(19) United States
(12) Patent Application Publication
(10) Pub. No.: US 2025/0298559 A1
(43) Pub. Date: Sep. 25, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Daisuke NOGUCHI, Kanagawa (JP)

(73) Assignee: FUJIFILM Business Innovation Corp., Tokyo (JP)

(21) Appl. No.: 18/799,058

(22) Filed: Aug. 9, 2024

(30) Foreign Application Priority Data
Mar. 21, 2024 (JP) 2024-045322

(51) Int. Cl. G06F 3/12

(52) U.S. Cl. CPC G06F 3/1229; G06F 3/1208; G06F 3/1259; G06F 3/126

(57) ABSTRACT

An information processing system includes: a processor configured to: when new input information including information on a new job and information on a worker performing work on the new job is input to a model, output involved time in response to the new input information wherein the model has been learned such that involved time for a job is output when input information including information on the job on print paper and information on the worker is input to the model.

### CROSS-REFERENCE TO RELATED APPLICATIONS

This application is based on and claims priority under 35 USC 119 from Japanese Patent Application No. 2024-045322 filed Mar. 21, 2024.

### BACKGROUND

### (i) Technical Field

The present disclosure relates to an information processing system, a non-transitory computer readable medium, and an information processing method.

### (ii) Related Art

Japanese Unexamined Patent Application Publication No. 2021-26535 discloses a print ordering system used to order printing in a factory as a service provider. The print ordering system identifies the type of and amount of paper sheets used in the factory in accordance with information collected from the factory and transmits to a supplier of the used paper sheets the identified type and amount of paper sheets.

In scheduling equipment in a printing industry, planned involved time for a print job is predicted and a usage plan of the equipment is formed based on the predicted involved time.

Since the involved time depends on equipment performance, characteristics of jobs and skill level of workers in charge, accurate calculation of the involved time is difficult.

In a current practice, involved time is typically predict with time to spare based on experience of printing work. More accurate calculation of the involved time may permit more accurate equipment scheduling.

### SUMMARY

Aspects of non-limiting embodiments of the present disclosure relate to providing an information processing system, a non-transitory computer readable medium and a method which may predict involved time for a job on print paper.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: when new input information including information on a new job and information on a worker performing work on the new job is input to a model, output involved time in response to the new input information wherein the model has been learned such that involved time for a job is output when input information including information on the job on print paper and information on the worker is input to the model.

### BRIEF DESCRIPTION OF THE DRAWINGS

Exemplary embodiment of the present disclosure will be described in detail based on the following figures, wherein:

FIG. 1 schematically illustrates an information processing system of an exemplary embodiment;

FIG. 2 is a block diagram illustrating an electrical configuration of a printer in the information processing system of the exemplary embodiment;

FIG. 3 is a block diagram illustrating an electrical configuration of a management apparatus and client computer in the information processing system of the exemplary embodiment;

FIG. 4 is a block diagram illustrating a functional configuration of the client computer in the information processing system of the exemplary embodiment;

FIG. 5 illustrates an example of a learned neural network model;

FIG. 6 is a flowchart illustrating a process flow example of a learning process performed on the client computer in the information processing system of the exemplary embodiment; and

FIG. 7 is a flowchart illustrating a process flow example of an estimation process performed on the client computer in the information processing system of the exemplary embodiment.

### DETAILED DESCRIPTION

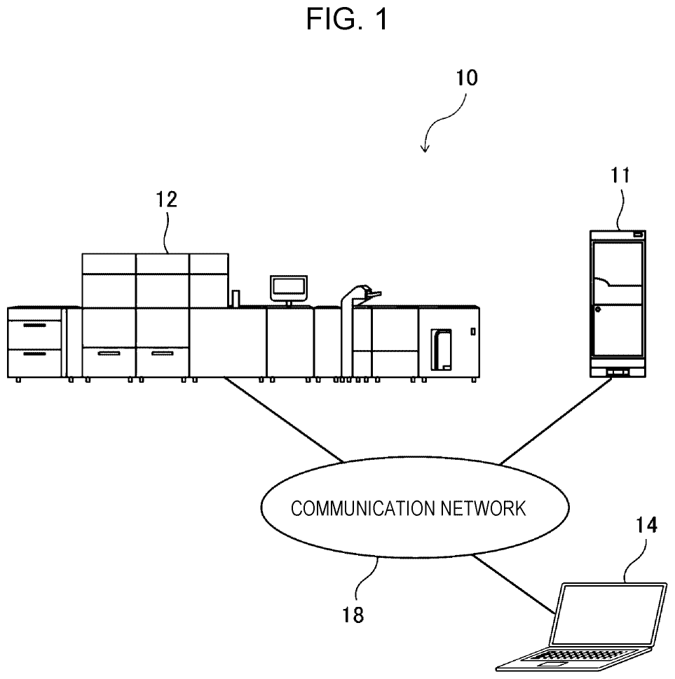

Exemplary embodiment of the disclosure is described below with reference to the drawings. The exemplary embodiment is related to an information processing system 10 including a management apparatus, printer, client computer and the like connected to each other via a communication network, including a variety of networks. FIG. 1 schematically illustrates the information processing system 10 of the exemplary embodiment.

Referring to FIG. 1, the information processing system 10 of the exemplary embodiment includes a management apparatus 11, printer 12, client computer 14 and the like. The management apparatus 11, printer 12, and client computer 14 are connected to each other via a communication network 18 including a local-area network (LAN), wide-area network (WAN), Internet and/or Intranet. The management apparatus 11, printer 12 and client computer 14 may exchange a variety of data to each other via the communication network 18. According to the exemplary embodiment, the printer 12 performs printing responsive to a print instruction when the print instruction is provided to the printer 12 from the client computer 14 via the management apparatus 11.

Referring to FIG. 1, each of the management apparatus 11, printer 12 and client computer 14 is a single standalone apparatus but one of these apparatuses may be a multi-apparatus system.

The printer 12 of the exemplary embodiment has multiple functions including a printing function that performs a printing operation, a post-process function that performs a post-process on the printed paper and other functions. The multiple functions may include a reading function that obtains image information representing a document by reading the document, a copying function that copies an image recorded on a document to a paper sheet, a facsimile function that transmits or receives a variety of data via a telephone network (not illustrated), a transfer function that transfers document information, such as image information that is read by the reading function, and a storage function that stores the read image information.

In the following discussion, the facsimile function, reading function, printing function and copying function may be occasionally respectively referred to as fax, scan, print and copy.

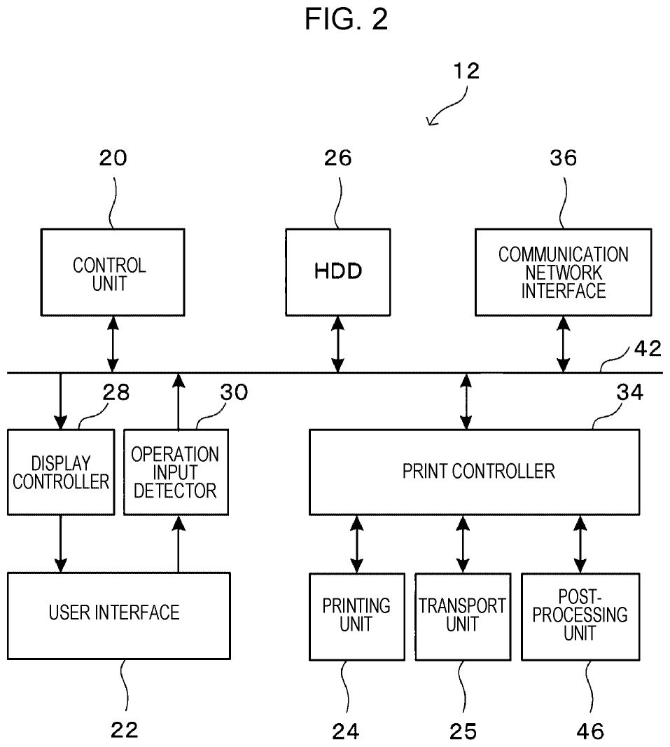

FIG. 2 is a block diagram illustrating an electrical configuration of the printer 12 in the information processing system 10 of the exemplary embodiment.

Referring to FIG. 2, the printer 12 of the exemplary embodiment may a control unit 20. The control unit 20 may include a central processing unit (CPU), read-only memory (ROM) and random-access memory (RAM).

The printer 12 of the exemplary embodiment further includes a hard disk drive (HDD) 26 that stores a variety of data and application programs. The printer 12 further includes a display controller 28 that is connected to a user interface 22 and controls displaying of a variety of screens on a display of the user interface 22. The printer 12 further includes an operation input detector 30 that is connected to the user interface 22 and detects an operation instruction input via the user interface 22. In the printer 12, a system bus 42 is electrically connected to the HDD 26, display controller 28 and operation input detector 30. In the printer 12 of the exemplary embodiment, a memory is the HDD 26 but alternatively, may be a non-volatile memory, such as a flash memory. In the exemplary embodiment, the user interface 22 is a touch panel that serves as a display capable of receiving an operational input but alternatively, the user interface 22 may include a display and an operation unit that are separate from each other.

The printer 12 of the exemplary embodiment includes a print controller 34 that controls a printing operation of a printing unit 24 and transport operation of a transport unit 25 transporting a paper sheet to the printing unit 24 and a post-process of a post-processing unit 46. The printer 12 may further include a reading controller that performs a reading operation of an optical document reader optically reading an image and a document transport operation of a document transport unit. The printer 12 is connected to the communication network 18 and further includes a communication network interface 36 that exchanges communication data with the client computer 14 connected to the communication network 18 or another external apparatus connected to the communication network 18. The printer 12 may include a fax interface 38 that exchanges fax data with a fax device connected to a telephone line (not illustrated). The printer 12 may include a transmission-reception controller that controls transmission and reception of the fax data via the fax interface 38. The print controller 34 and communication network interface 36 are electrically connected to a system bus 42 in the printer 12.

The control unit 20 in the printer 12 of the exemplary embodiment thus constructed controls an operation screen of the display of the user interface 22 and a display operation of information, such as a variety of messages via the display controller 28. The control unit 20 in the printer 12 controls operations of the printing unit 24, transport unit 25 and post-processing unit 46 via the print controller 34 and exchange of the communication data via the communication network interface 36. The control unit 20 in the printer 12 recognizes operation contents on the user interface 22 in accordance with operation information detected by the operation input detector 30 and thus performs a variety of controls in response to the operation contents.

Applications stored on the HDD 26 include, for example, an application performing a function, such as printing.

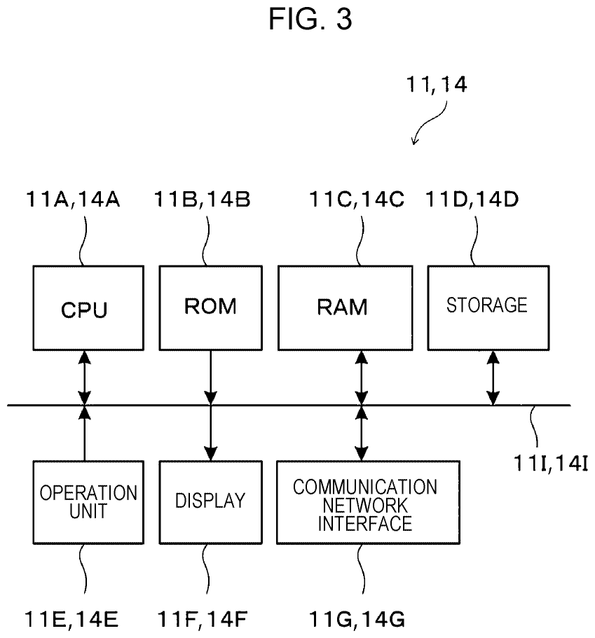

The electrical configuration of the management apparatus 11 and client computer 14 of the exemplary embodiment is described below. FIG. 3 is a block diagram illustrating the electrical configuration of the management apparatus 11 and client computer 14 in the information processing system 10 of the exemplary embodiment. The management apparatus 11 and client computer 14 have a typical computer configuration and only the management apparatus 11 is described herein.

As illustrated in FIG. 3, the management apparatus 11 of the exemplary embodiment includes a CPU 11A, ROM 11B, RAM 11C, storage 11D, operation unit 11E, display 11F and communication network interface 11G. The CPU 11A controls the whole operation of the management apparatus 11. The ROM 11B pre-stores a variety of control programs and a variety of parameters. The RAM 11C is used as a working area when the CPU 11A executes the programs. The storage 11D stores a variety of data and application programs. The operation unit 11E is used to input a variety of information. The display 11F is used to display a variety of information. The communication network interface 11G is connected to the communication network 18 and exchanges a variety of data with another apparatus connected to the communication network 18. The communication network interface 11G may be configurated to communicate with apparatuses using a variety of wireless communications of the related art. The elements of the management apparatus 11 described above are electrically connected to each other via a system bus 11I. The storage 11D is used in the management apparatus 11 of the exemplary embodiment but alternatively, a non-volatile memory, such as an HDD or flash memory, may be used in the management apparatus 11.

The CPU 11A in the management apparatus 11 of the exemplary embodiment thus constructed accesses the ROM 11B, RAM 11C and storage 11D, retrieves a variety of data from these memories via the operation unit 11E and displays a variety of information on the display 11F. The CPU 11A in the management apparatus 11 controls exchange of communication data via the communication network interface 11G.

The management apparatus 11 in the information processing system 10 thus constructed manages a series of manufacturing processes. The series of manufacturing processes include a production process, pre-press process, pressplate process, printing process, processing process and delivery process.

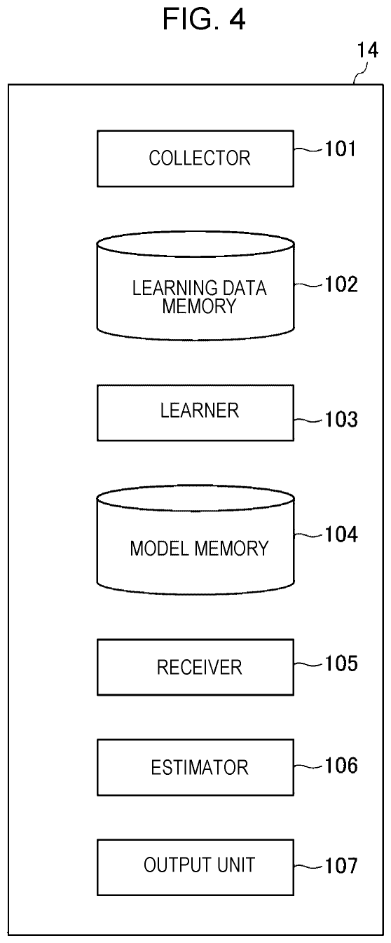

Functional configuration of the client computer 14 is described below. FIG. 4 is a block diagram illustrating the functional configuration of the client computer 14.

The client computer 14 is functionally configurated as illustrated in FIG. 4 to include a collector 101, learning data memory 102, learner 103, model memory 104, receiver 105, estimator 106 and output unit 107.

The collector 101 collects learning data including input information on a past print job paired with involved time of the print job responsive to the input information.

The input information may include information on the print job. Specifically, the information on the print job may include the number of printed materials to be printed in the print job, the number of printed materials to be processed, information on a color to be printed in the print job or type of a processing operation in the print job. Specifically, the number of printed materials is the number of copies or the number of pages of printed materials. For example, the information on the color to be printed is cyan, magenta, yellow and black (CMYK), only black and the presence or absence of a special color. The type of the processing operation includes stapling, punching, folding, cutting and the like.

The management apparatus 11 stores log information used to manage information on orders of printed materials and manufacturing information.

The collector 101 collects the information on the print job from the log information stored on the management apparatus 11.

The input information may include information on a worker performing work on the print job. Specifically, the information on the worker is information identifying the worker (for example, name or identity (ID) of the worker).

The collector 101 retrieves the information on the worker performing work on the print job from the log information stored on the management apparatus 11.

The input information may include information on equipment processing the print job. The information on the equipment may include information identifying the equipment (for example, the name or ID of the equipment), information indicating the type of the equipment (for example, the name or ID of the type of the equipment) or information indicating the performance of the equipment. The information indicating the performance of the equipment includes the printing speed or processing speed of the equipment.

The collector 101 retrieves the information on the equipment processing the print job from the log information stored on the management apparatus 11.

The involved time of a past print job is managed as the log information by the management apparatus 11 and the collector 101 retrieves the involved time of the print job from the management apparatus 11.

Specifically, the worker inputs to the management apparatus 11, as past record information on the print job of the worker, the information on the used equipment, work start time and work completion time and the past record information is managed as the log information on the management apparatus 11. The collector 101 retrieves the involved time of the print job calculated from the work start time and work completion time. It may be acceptable to automatically input to the management apparatus 11 the information on the used equipment, work start time and work completion time as the past record information of the print job of the worker.

The learning data memory 102 stores multiple pieces of learning data collected by the collector 101.

The learner 103 constructs in accordance with the learning data a neural network model that estimates the involved time of the print job responsive to the input information input to the neutral network model.

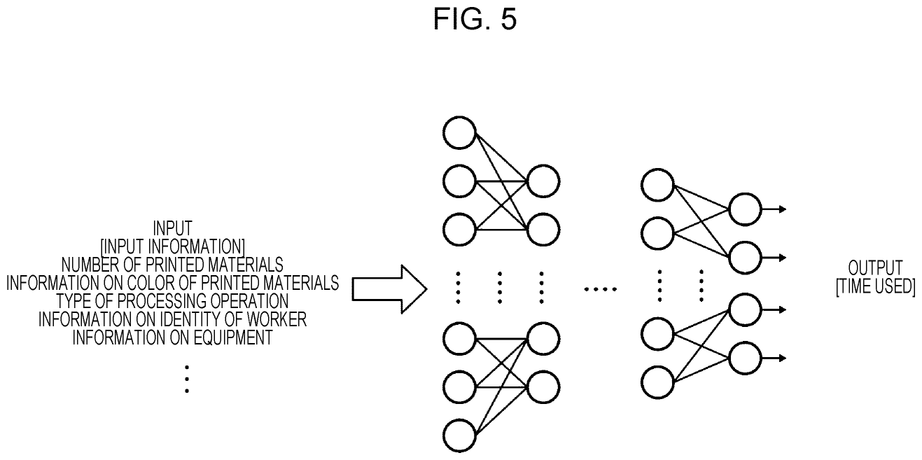

Specifically, the learned neural network model receives the input information including at least one piece of the information on the number of printed materials, information on the color printed, information on the type of the processing operation, information identifying the worker and information on the equipment and outputs the involved time of the print job responsive to the input information (see FIG. 5). Deep learning may be used as an example of an learning algorithm and the neural network model may be constructed such that the involved time of the print job of the learning data is output when the input information as the learning data is received.

Specifically, parameters of the model may be updated in a manner such that the involved time is estimated as the output of the model with the input information as the learning data received, the estimated involved time of the print job is compared with the involved time of the print job of the learning data, an error between the involved times of the print job is calculated and then the value of the error is minimized.

Correlation between each piece of the input information and the involved time of the print job is described below.

Even when the information on the equipment is not input, which equipment to be used may be found from the information on the print job. The equipment in use affects the involved time of the print job. A correlation is thus present between the information on the print job and the involved time of the print job.

The skill level of the worker affects the involved time of the print job. Even when the information on the equipment is not input, the information identifying the worker may help determine which worker uses more frequently which equipment. A correlation is thus present between the information identifying the worker and the involved time of the print job.

Performance of the equipment affects the involved time of the print job. A correlation is thus present between the information on the equipment and the involved time of the print job.

The model memory 104 stores the learned neural network model.

The receiver 105 receives the input information on a new print job serving as an estimation target.

The input information includes the information on the print job. The information on the print job may include the number of printed materials printed in the print job, the number of printed materials processed in the print job, information on the color printed in the print job or information on the type of the processing operation in the print job. For example, the receiver 105 receives “1000 copies” as the number of printed materials, “800 copies” as the number of printed materials processed, “YMCK” as the information on the color printed in the print job, or “cutting” as the type of the processing operation in the print job, retrieved from the management apparatus 11.

The input information may further include the information on the worker performing work on the print job. For example, the receiver 105 receives the information identifying the worker and retrieved from shift information of the worker managed by the management apparatus 11.

The input information may include the information on the equipment processing the print job. The information on the equipment processing the print job may include the information identifying the equipment, information indicating the type of the equipment or information indicating the performance of the equipment. For example, the receiver 105 receives the information identifying the equipment, information indicating the type of the equipment or “printing speed of 30 page per minute (ppm)” as the information indicating the performance of the equipment, retrieved from the management apparatus 11.

The estimator 106 estimates the involved time of the print job responsive to the received input information, using the learned neural network model stored on the model memory 104.

Specifically, the estimator 106 converts a variety of information included in the received input information into data in a data structure supported by the learned neural network model, inputs the data to the learned neural network model and estimates the involved time of the print job from the output from the learned neural network model.

The output unit 107 presents to the user the estimated involved time of the print job. In this way, the user may reference the estimated involved time of the print job and make a schedule of the print job.

A specific process of the information processing system 10 of the exemplary embodiment thus constructed is described below.

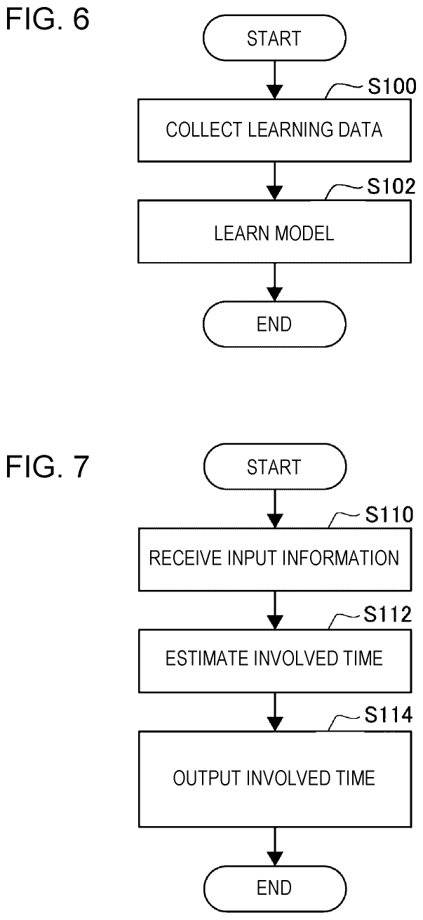

The CPU 14A in the client computer 14 performs the learning process illustrated in FIG. 6 by reading a learning program from the ROM 14B or storage 14D and loading the learning program on the RAM 14C.

In step S100, the CPU 14A operating as the collector 101 collects learning data including input information on a past print job paired with involved time of a print job responsive to the input information and stores the learning data on the learning data memory 102.

In step S102, the CPU 14A operating as the learner 103 learns in accordance with multiple pieces of learning data a neural network model that estimates involved time of a print job in response to the input information that is input to the neural network model. The CPU 14A thus completes the learning process by storing the learned neural network model on the model memory 104.

The CPU 14A in the client computer 14 reads an estimation program from the ROM 14B or storage 14D, loads the estimation program on the RAM 14C, executes the estimation program on the RAM 14C and thus performs an estimation process illustrated in FIG. 7. It is assumed that the variety of information included in the input information on the print job has been input.

In step S110, the CPU 14A operating as the receiver 105 receives the input information input by a user and related to the print job serving as the estimation target.

In step S112, the CPU 14A operating as the estimator 106 estimates the involved time of the print job responsive to the received input information using the learned neural network model stored on the model memory 104.

In step S114, the CPU 14A operating as the output unit 107 completes the estimation process by presenting to the user the estimated involved time of the print job. The users references the estimated involved time of the print job and makes a schedule of the print job.

Through the processes as described above, the involved time of the job on the printed material may be predicted in view of the information on the print job and the information on the worker performing work on the print job.

### MODIFICATIONS

The disclosure is not limited to the exemplary embodiment and may be modified or applied in a variety of forms without departing from the scope of the disclosure.

In the exemplary embodiment, the learned neural network model estimates the involved time of the print job including the printing operation and processing operation. The disclosure is not limited to this method. The learned neural network model may estimate the involved time of a job including only the printing operation or the involved time of a job including only the processing operation.

The involved time of the print job is estimated by receiving a variety of pieces of information included in the input information. Alternatively, after receiving a subset of, rather than all of, the pieces of the input information, the involved time may be estimated.

In the exemplary embodiment, the client computer 14 estimates the involved time of the print job while learning the model. Alternatively, the client computer 14 may be configurated to be divided into a learning apparatus that learns the model and an estimating apparatus that estimates the involved time of the print job.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The “system” in the exemplary embodiment includes multiple apparatuses but alternatively may include a single apparatus that is provided with a function of a subset of the apparatuses.

The process of the printer 12 of the exemplary embodiment may be performed using software, hardware or both. The process of the printer 12 may be stored as a program on a memory and then the memory with the program recorded thereon may be delivered.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:

a processor configured to:
when new input information including information on a new job and information on a worker performing work on the new job is input to a model, output involved time in response to the new input information wherein the model has been learned such that involved time for a job is output when input information including information on the job on print paper and information on the worker is input to the model.
   (((2)))

In the information processing system according to (((1))), the information on the job includes the number of printed materials printed in the job, the number of printed materials processed in the job, information on a color printed in the job or a type of a processing operation in the job.

(((3)))

In the information processing system according to one of (((1))) and (((2))), the information on the worker includes information identifying the worker.

(((4)))

In the information processing system according to one of (((1))) through (((3))), the input information and the new input information further include information on equipment processing the job.

(((5)))

In the information processing system according to (((4))), the information on the equipment processing the job includes information identifying the equipment, information indicating a type of the equipment or information indicating performance of the equipment.

(((6)))

A program causing a computer to execute a process, the process including:
when new input information including information on a new job and information on a worker performing work on the new job is input to a model, outputting involved time in response to the new input information wherein the model has been learned such that involved time for a job is output when input information including information on the job on print paper and information on the worker is input to the model.

What is claimed is:

1. An information processing system comprising:
a processor configured to:
when new input information including information on a new job and information on a worker performing work on the new job is input to a model, output involved time in response to the new input information wherein the model has been learned such that involved time for a job is output when input information including information on the job on print paper and information on the worker is input to the model.

2. The information processing system according to claim 1, wherein the information on the job comprises a number of printed materials printed in the job, a number of printed materials processed in the job, information on a color printed in the job or a type of a processing operation in the job.

3. The information processing system according to claim 1, wherein the information on the worker comprises information identifying the worker.

4. The information processing system according to claim 1, wherein the input information and the new input information further comprise information on equipment processing the job.

5. The information processing system according to claim 4, wherein the information on the equipment processing the job comprises information identifying the equipment, information indicating a type of the equipment or information indicating performance of the equipment.

6. A non-transitory computer readable medium storing a program causing a computer to execute a process, the process comprising:
when new input information including information on a new job and information on a worker performing work on the new job is input to a model, outputting involved time in response to the new input information wherein the model has been learned such that involved time for a job is output when input information including information on the job on print paper and information on the worker is input to the model.

7. An information processing method comprising:
when new input information including information on a new job and information on a worker performing work on the new job is input to a model, outputting involved time in response to the new input information wherein the model has been learned such that involved time for a job is output when input information including information on the job on print paper and information on the worker is input to the model.
